(19) United States
(12) Patent Application Publication
(10) Pub. No.: US 2026/0074784 A1
(43) Pub. Date: Mar. 12, 2026

(54) NETWORKED FORWARD TRANSMISSION-BASED OPTICAL NETWORK ANOMALY DETECTION

(71) Applicant: NEC Laboratories America, Inc., Princeton, NJ (US)

(72) Inventors: Philip JI, Cranbury, NJ (US); Yue-Kai HUANG, PRINCETON, NJ (US); Ting WANG, West Windsor, NJ (US); Zilong YE, La Verne, CA (US)

(73) Assignee: NEC Laboratories America, Inc., Princeton, NJ (US)

(21) Appl. No.: 18/801,010

(22) Filed: Aug. 12, 2024

Related U.S. Application Data
(60) Provisional application No. 63/532,343, filed on Aug. 11, 2023.
(60) Provisional application No. 63/590,846, filed on Oct. 17, 2023.

(51) Int. Cl. H04B 10/079

(52) U.S. Cl. CPC H04B 10/0791

(57) ABSTRACT

Disclosed are systems, and methods providing optical network anomaly detection and localization based on forward transmission sensing and route optimization and network-wide global planning of sensing routes. Multiple sensing routes are selected to cover the entire network and each link in the network is guaranteed to contain a different combination of sensing routes. These routes are then monitored concurrently and analyzed centrally. When an anomalous event occurs at a specific link, receivers in the corresponding routes will detect optical characteristic changes. Since the sensing route combination is unique for each link, a global analysis of the optical characteristic change will indicate the exact link that causes the event.

### CROSS-REFERENCE TO RELATED APPLICATIONS

This application claims the benefit of U.S. Provisional patent application Ser. No. 63/532,343 filed 11 Aug. 2023, and U.S. Provisional patent application Ser. No. 63/590,846 filed 17 Oct. 2023, the entire contents of each is incorporated by reference as if set forth at length herein.

### FIELD OF THE INVENTION

This application relates generally to optical networking. More particularly, it pertains to forward, transmission-based sensing systems, methods, and structures that facilitate the monitoring of optical networks and provide anomaly detection.

### BACKGROUND OF THE INVENTION

Optical networks constructed from optical fibers form the backbone of contemporary global communications. As such, it is necessary to monitor network conditions in real-time, to ensure the proper operation of such networks.

Currently, a common method to monitor optical networks include fiber attenuation measurement by optical time-domain reflectometry (OTDR), error measurement by optical transponder or bit-error rate (BER) tester, and optical spectrum measurements by optical spectrum analyzer (OSA). While these methods can detect optical fiber cuts and abnormal fiber loss, there are many other abnormal events that cannot be detected by observation of attenuation profile, error rate, or spectrum. Such events include construction activity near optical fibers, landslides and other geologic activities.

Distributed fiber optic sensing (DFOS) systems, methods, and structures including distributed vibration sensing (DVS) and distributed acoustic sensing (DAS) have found widespread utility in contemporary industry and society including monitoring abnormal events in optical networks. By detecting vibrations caused by abnormal events, such events can be detected and localized by DFOS/DVS/DAS. However, since these techniques are based on backscatter of optical interrogator signals, metro and longer optical networks including optical amplifiers having isolators prevents their use.

### SUMMARY OF THE INVENTION

An advance in the art is made according to aspects of the present disclosure directed to systems, and methods for network monitoring in which networked forward transmission-based sensing is used to monitor entire optical networks exhibiting any topology. In sharp contrast to the prior art, systems and methods according to the present disclosure employ network-wide intelligent global planning of sensing routes (i.e. the placement of transmitter and the receiver of each transmission route) and coordinated processing, anomalies occurring in the optical network are detected instantly, and any affected link(s) identified—while keeping transmission hardware at a minimum. Consequently, our inventive systems and method provide an efficient, economical, and rapid method to monitor large scale optical networks (hundreds or thousands of kilometers per route, with regular amplification configurations) for continuous network health monitoring and anomaly detection.

As we shall show and describe further, our inventive systems and methods include:

Forward transmission-based sensing, which advantageously allows long distance sensing with little or no modification of existing optical transponders, while working effectively in networks with optical amplifiers.

Multiple sensing routes are used to monitor the entire optical network continuously and concurrently and not just a point-to-point transmission link.

An intelligent sensing route planning method that identifies a specific link exhibiting an anomalous event-instantly.

The intelligent sensing route planning method minimized the number of sensing routes employed thereby minimizing required transmission equipment.

A centralized controller is employed to manage sensing route configuration and event analysis.

Our inventive heuristic algorithm aims at assigning the minimum number of sensing routes such that (1) each link is sensed or covered at least by one sensing route and (2) each link is associated with a unique binary code that is not all 0s (which indicates no anomaly event). Here, the code between different links is required to be non-identical, so that the anomaly event can be localized immediately. The proposed heuristic algorithm is a greedy algorithm that includes four steps.

Firstly, it applies breadth-first search to obtain all the routes that originate from each node with a maximum of k hops.

Secondly, a matrix T with links as rows (N rows) and all the routes as columns (M columns) can be constructed, here, T[i][i] is 1 if route j passes through link i; 0 otherwise.

Thirdly, the algorithm examines each route and selects the one that introduces the minimum number of identical codes between links for deploying a new sensing route. This step repeats until there is no identical code between different links.

Finally, after the above iteration is complete, if one of the links has a code consisting of all 0s, a new sensing route (only one hop) will be deployed to just cover this particular link. This is because, even if all 0s is a unique code, it represents there is no abnormal optical characteristic change found at any route, which cannot be used for identifying anomaly event at any link.

### BRIEF DESCRIPTION OF THE DRAWING

FIG. 1 is a schematic diagram showing an illustrative optical network for anomaly detection according to aspects of the present disclosure.

FIG. 2 is a schematic diagram showing an illustrative optical network for anomaly detection and example sensing route planning for network monitoring according to aspects of the present disclosure.

FIG. 3 shows anomaly detection and analysis example data using three (3) sensing routes to monitor a meshed network with seven (7) links such as that illustratively shown in FIG. 2, according to aspects of the present disclosure.

FIG. 4 shows an illustrative distributed fiber optic sensing (DFOS) sensing fiber route/channel according to aspects of the present disclosure.

FIG. 5 is a schematic diagram showing an illustrative optical network for anomaly detection and distributed fiber optic sensing (DFOS) anomaly event detection and localization in a mesh (network) topology according to aspects of the present disclosure.

FIG. 6 is a schematic block diagram showing an illustrative optical network for anomaly detection according to aspects of the present disclosure.

FIG. 7 shows a set of data for network link encodings for failure detection of the illustrative optical network of FIG. 6, according to aspects of the present disclosure.

FIG. 8, FIG. 9, and FIG. 10 are flow diagrams that collectively show a main, computer-implemented procedure for network anomaly detection and localization according to aspects of the present disclosure.

FIG. 11 is a flow diagram that shows a computer-implemented sub-procedure for matrix construction for network anomaly detection and localization according to aspects of the present disclosure.

FIG. 12 is a flow diagram that shows a computer-implemented sub-procedure for counting the number of identical encodings between links for network anomaly detection and localization according to aspects of the present disclosure.

FIG. 13 is a flow diagram that shows a computer-implemented sub-procedure for generating encodings for each link for network anomaly detection and localization according to aspects of the present disclosure.

FIG. 14 is a flow diagram that shows a computer-implemented sub-procedure for sensing fiber routes/channels for network anomaly detection and localization according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGURES comprising the drawing are not drawn to scale.

By way of some additional background, we note that forward-based sensing technology has been recently proposed and demonstrated as a possible technology to address difficulties with optical network anomaly detection and localization. As will be understood and appreciated, instead of relying on backscatter of incident light, an optical signal emitted from a source travels only in a forward direction from a source and is detected at a destination receiver. Such operations is accordingly known as “transmission-based” sensing.

Advantageously, various types of sensing technologies can be employed in transmission-based sensing systems, including a detection of a state-of-polarization (SoP), the polarization rotation matrix, and the relative phase (phase rotation) of received light, etc. As those skilled in the art will understand and appreciate, a relative phase of a transmission link has been employed to measure an earthquake using a 535 km terrestrial fiber link as a sensor, while exhibiting a potential for >10,000 km detection(s). Similarly, SoP has shown the ability to detect earthquakes over a 10,500 km transcontinental fiber optic cable.

These examples establish that various types of transmission-based sensing technologies are effective for long distance (>10,000 km) fiber optic link monitoring, and unlike scattering methods, amplifiers (repeaters) do not present any debilitating issue(s). Also, contrary to backscattering-based DFOS which requires costly dedicated interrogating equipment, transmission-based sensing techniques require little modification of existing fiber optic transmission hardware. Advantageously, some transmission-based techniques do not require any modification at all. For example, SoP information (such as the maximum, minimum, average SoP change) is typically available at an optical transponder, and can be directly used for sensing applications.

However, a major drawback of the transmission-based sensing is the inability to localize the event. Unlike backscattering-based sensing technologies which use time-of-flight to identify an event location along the length of an optical fiber, transmission-based sensing does not provide such capability. Therefore, transmission-based sensing only reports whether an anomalous event occurs, but not the event location along the length of an optical fiber. It is possible to use multiple cables and the seismic wave propagation speed to estimate the seismic event, but the spatial resolution is low. This might be sufficient for earthquake detection, but not for general optical network monitoring.

A scheme using phase correlation between bidirectional transmissions has been demonstrated to achieve detection and localization of vibration events over 380 km of installed field fiber using telecommunications transponders. However, localization accuracy using such a forward transmission-based bidirectional phase correlation scheme is inversely proportional to the bandwidth of the vibration signal above ambient noise, which include ambient vibrations of the environment, as well as laser phase noise and ASE of the link. Consequently, it is not very practical.

Finally, we note that all these forward transmission-based techniques are for single point-to-point transmission links, and do not consider network-wide monitoring. Of course, one can monitor each link in the network with a dedicated point-to-point sensing system, however such monitoring would be quite costly. As a result, an effective, low cost method to perform continuous monitoring on each link in an optical network and provide instant anomaly reporting would represent a significant advance in the art.

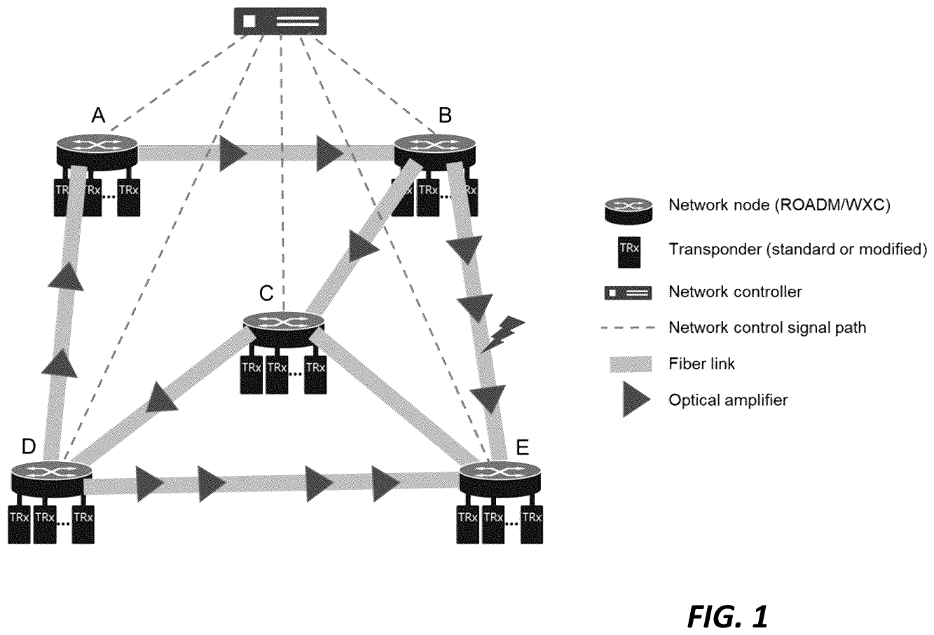

FIG. 1 is a schematic diagram showing an illustrative optical network for anomaly detection according to aspects of the present disclosure. With reference to this figure, it may be observed that there are 5 nodes (A to E). Each node is typically a ROADM (reconfigurable optical add/drop multiplexer) node or a WXC (wavelength cross-connect) node with local add/drop functions.

In each node, the WDM (wavelength division multiplexed) channels can be switched among different degrees (i.e. in/out ports) optically, typically by demultiplexing the WDM channels from the input ports into individual wavelength channels or wavebands, routing them to the target destination using optical switches, and then multiplexing them before existing the node. Each node can also has some optical transponders attached. Besides those “through traffics”, the optical node can also add optical channels from local transponders and send them to designated output ports or drop optical channels from input ports to the local transponders. As those skilled in the art will understand and appreciate, these are called the “local traffics”.

In the example shown in this figure, there are 7 links (AB, AD, BC, BE, CD, CE, and DE). Those skilled in the art will understand and appreciate that there are usually optical amplifiers in the links, and that these links are typically bidirectional since data communication is generally symmetric between two nodes. In operation, the optical amplifiers will amplify optical signals traversing the network in both directions. For simplicity however, the amplifiers are drawn as unidirectional in this figure.

Shown further in the figure is a network controller that commands each node to set any switching and add/drop configurations.

According to aspects of the present disclosure, forward transmission-based sensing is used to monitor the entire network (here we mainly refer to monitoring all links, since the node failure can be detected and reported by the node itself). Therefore, transmission routes for sensing are planned and established. Each sensing route starts from a transponder at the source node, which sends the optical signal to the corresponding transponder at the destination node. Each route can consist of more than one link. For example, the route can start from Node A, passes through Node B, and ends at Node E. In this example, the transmitter of the sensing signal is the source transponder at Node A, the receiver of the sensing signal is the destination transponder at Node E, and Node B is the intermediate node, which only routes the wavelength without local add/drop.

As noted, the transponders shown can be conventional WDM communication transponders if information needed for anomaly detection is available in the transponder (such as the SoP). They can also be modified to provide additional information (such as relative phase, which are not typically provided in typical WDM transponders). Or they can also be dedicated forward transmission-based sensing channels (dedicated transponders).

When an anomaly occurs at the network (such as the lightning strike on Link BE), the optical property of the WDM channels transmitted through this link will experience corresponding changes, such as SoP change or relative phase change. This includes those optical channels used for sensing. Such changes will be observed/detected by the receiver at the destination node instantly. However, as described earlier, it cannot detect the exact location of the event. Using the example above, if the sensing route is A-B-E, when the anomaly event occurs at the Link BE, the sensor will report that an anomaly occurs within the route but cannot tell whether it is in Link AB or in Link BE.

However, if there is another sensing route A-B-C, the anomaly event at Link BE will not cause optical signal change in this route, therefore we can know that both Link AB and Link BC are without anomaly event. Combing the results in both routes (A-B-E and A-B-C), we can identify that the anomaly occurs at Link BE. This is the basic principle of coordinated network monitoring, in which multiple sensing routes are planned together and the sensing results are analyzed concurrently to identify which link the anomaly occurred.

Once the link is identified, further diagnosis and action can be taken, such as dispatching a technician to inspect the identified link or applying/utilizing other instruments having a finer spatial resolution to further monitor the link.

In such a network monitoring and analysis scheme, it is desirable to reduce the number of sensing routes, if each link can be monitored and identified. This improves monitoring efficiency, because it not only reduces the hardware expense, but also simplifies the analysis.

In the example illustratively shown in FIG. 1, a simple way is to set up 1 sensing route (i.e. 1 transmitter-receiver pair) to monitor each link individually. But this will require 7 transmitter-receiver pairs to monitor all 7 links in this network, which is not efficient.

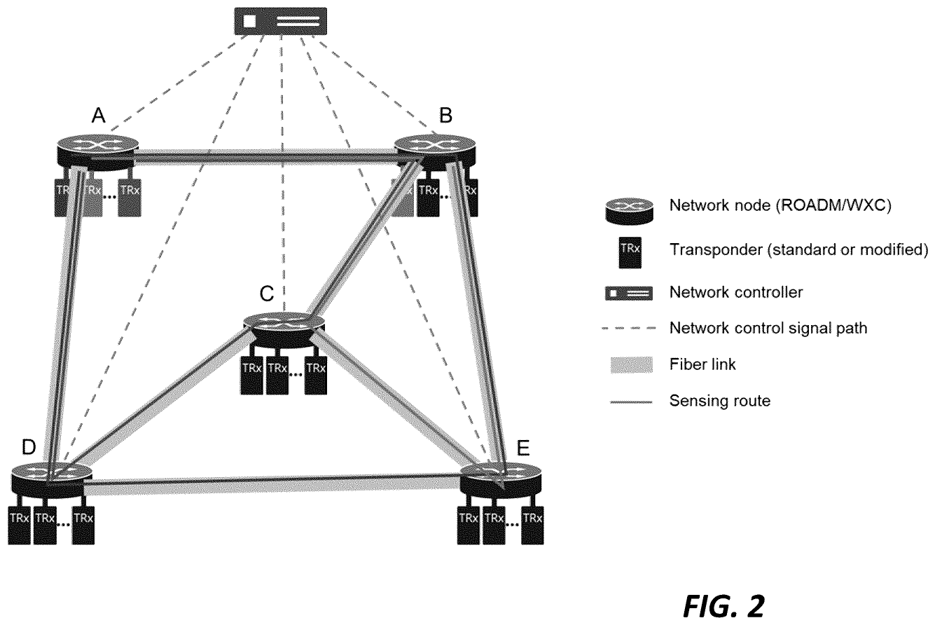

FIG. 2 is a schematic diagram showing an illustrative optical network for anomaly detection and example sensing route planning for network monitoring according to aspects of the present disclosure. As illustratively shown in this figure is an example of optimal sensing route planning. For clarity, the amplifiers are not shown here. In this configuration, only 3 sensing routes are needed, namely A-B-E-D-A, A-B-C-E-B, and A-B-C-D-A.

As those skilled in the art will understand and appreciate, these 3 sensing routes are sufficient to monitor the entire network with 7 links, as shown in Table 1 below. Here, 0 means that no event is detected in the route, and 1 means that an anomaly is detected in the route. The 8 result cases cover anomaly at all 7 individual links, plus the normal state where no event occurs.

Since each sensing route only needs to report whether this is an anomaly occurring (which can be easily done in real-time), and since the analysis is very simple and straightforward (in this example, it is just the processing of a three-bit binary numbers), the overall network analysis can be done instantly (much shorter than 1 second).

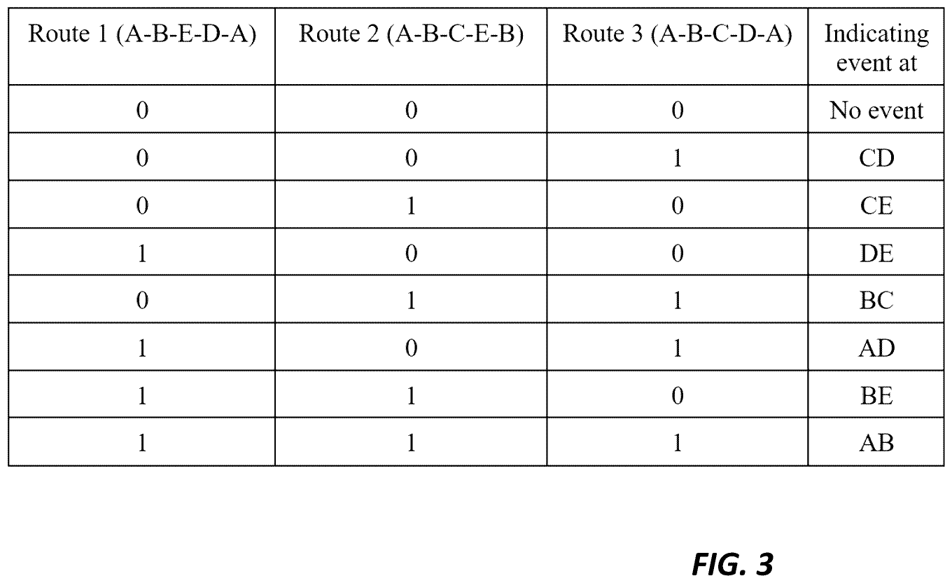

Here we assume that only one anomaly event occurs, and the scheme is designed for cases with single event, as shown in FIG. 3, which shows anomaly detection and analysis example data using three (3) sensing routes to monitor a meshed network with seven (7) links such as that illustratively shown in FIG. 2, according to aspects of the present disclosure.

Advantageously, even though it is possible that there are multiple events occurring concurrently—albeit very rare—this scheme still works. The reason is that even if multiple events occur, it is highly unlikely that more than 1 event occurs simultaneously. If there is a brief moment of a gap of time (e.g. 1 second) between the events, the first one can be detected correctly using the scheme before the second event occurs. With the knowledge of the first event, the subsequent events can also be detected accurately.

At this point we offer the following observations on sensing route planning according to aspects of the present disclosure.

First, N sensing routes can detect and localize events (i.e. identify the link) in the network with up to 2^{N}−1 links using a simple N-bit binary calculation. This is a theoretical limit for networks with ideal configuration, therefore it is not likely to be always achieved.

Second, the transmission direction of the link does not matter. For example, A-B-C route with Node A as the source node and Node C as the destination will function the same as C-B-A route where Node C is the source node and Node A is the destination node.

Third, for a ring route, such as the Route 1 (A-B-E-D-A) in the example above, the source node and the destination node are the same, and any node in the ring can be used as the source/destination node.

Finally, since the sensing route is unidirectional (unlike data communication, which is typically bidirectional), only a single direction optical amplifier is needed.

In the beginning of the operation, the sensing routes are designed by the network controller since it has the information of the network (topology, nodes, links, etc.). It can use a network planning algorithm (not described in this document) to find the optimum routing plan to minimize the sensing routes while covering the entire network with individual link identification capability. It then sends the routing configuration to each node, which performs routing or add/drop operation accordingly.

During the operation, each sensing route continuously monitors the targeted optical parameters and reports the status to the controller (i.e. with or without anomaly). The network controller then combines these reports with time synchronization and performs the network analysis. As described above, if an anomaly occurs at a particular link, the network controller can detect it and identify the specific link instantly.

### Route Selection

As we have previously noted, forward transmission-based sensing technologies advantageously do not rely on the backscattering of optical pulses. Instead, the temporal variation of optical characteristics, such as state of polarization (SoP) or phase, are analyzed to detect the physical events (anomalies such as seismic events, tilting utility poles, falling tree branches, construction events nearby, cable sabotage, etc.) occurred on the fiber optic cables.

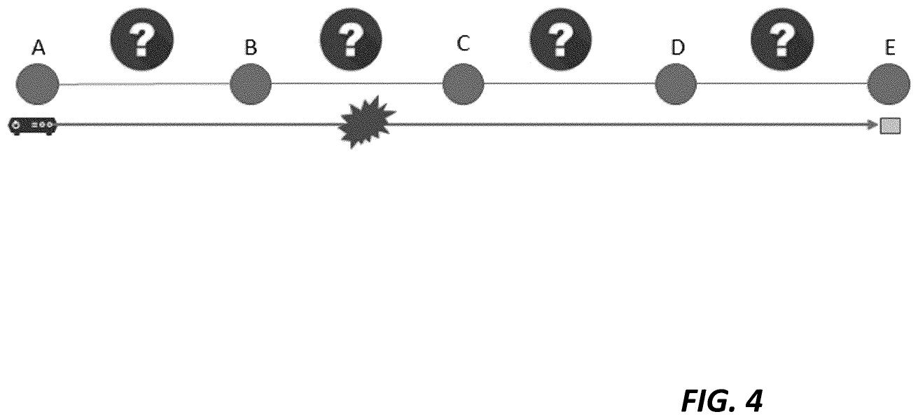

FIG. 4 shows an illustrative distributed fiber optic sensing (DFOS) sensing fiber route/channel according to aspects of the present disclosure. As illustratively shown in that FIG. 4, a forward transmission-based sensing fiber route (can also be described as a sensing fiber channel) A-B-C-D-E is established to monitor the route from node A to node E, which includes 4 links (AB, BC, CD, and DE) (a sensing fiber route usually spans across multiple physical network links). When an anomaly is detected, it is impossible to identify the location of the event, or which link the event occurs.

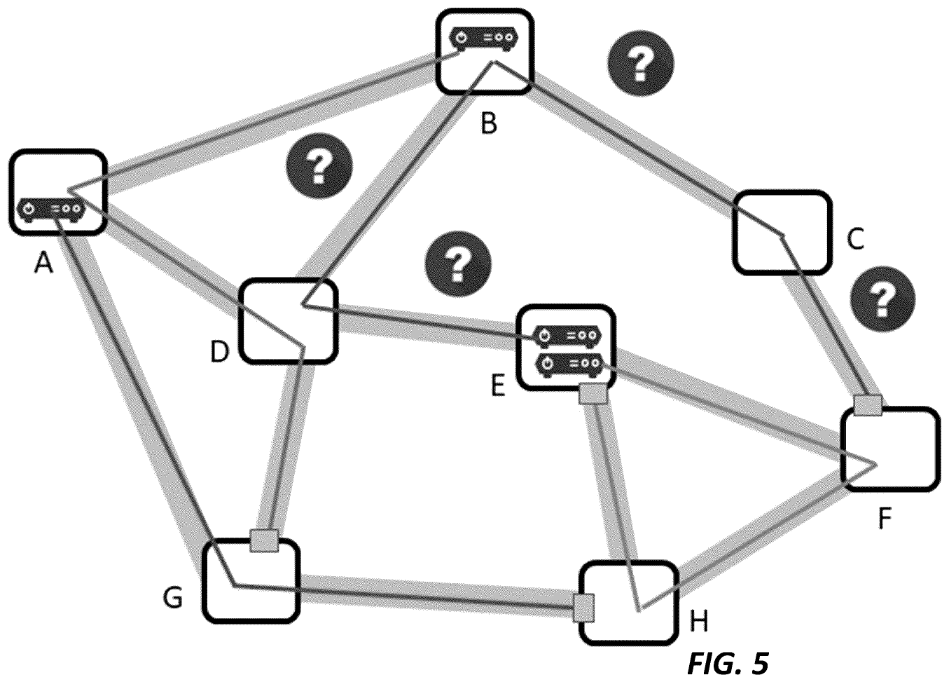

As we noted, several techniques were proposed in the past few years to solve this issue, including bidirectional transmission or repeater loopback. However, these techniques require complex system modification and high-cost hardware components, and still only have limited localization capability. In addition, all these techniques are for single point-to-point transmission link, and do not consider network-wide monitoring. However, most terrestrial metro and long-haul optical networks are not just a point-to-point links, but contain multiple nodes and links connected in different topologies, as shown in FIG. 5, which is a schematic diagram showing an illustrative optical network for anomaly detection and distributed fiber optic sensing (DFOS) anomaly event detection and localization in a mesh (network) topology according to aspects of the present disclosure.

In many network anomaly monitoring applications, identifying which link the anomaly occurs is sufficient. According to aspects of the present disclosure, we described a system and telemetry scheme for network monitoring. In this system, networked forward transmission-based sensing is used to monitor the entire network with any topology. By network-wide global planning of the sensing routes (i.e. the placement of transmitter and the receiver of each transmission route) and coordinated processing, the anomalies occurred in the network can be detected instantly, with the occurred link identified. This will provides an effective and economical solution to monitor large scale optical networks (multiple nodes and links, various topologies, hundreds or thousands of kilometers per route, with regular amplification configurations) for continuous network health monitoring and anomaly detection and localization.

To apply this network anomaly detection scheme, it is desirable to keep the number of sensing fiber routes to a minimum while still covering the entire network with per-link identification capability. Even though the existing transmission hardware for data communication might be able to be used to provide the information for forward transmission-based sensing, minimizing the sensing route will make the operation more efficient and reduce the complexity. Also, some forward transmission-based sensing systems use dedicated transmission hardware and wavelength channels. Therefore, minimizing the sensing route will help to reduce the hardware cost and the wavelength resource requirement.

A straightforward method to find the optimum number of sensors and the corresponding sensing route arrangement is to generate all possible routes, then find the combinations that can satisfy the monitoring requirement (e.g. cover the entire network with per-link localization), and then find the one with minimum number of routes. However, this method has very high computation complexity, therefore is very time consuming, and when the network scale becomes larger, it even becomes impossible to solve even with high performance computers.

Therefore, it is very useful to find an efficient method to calculate the minimum number of sensing routes required to serve the entire network, and to determine the path of each sensing route.

As we shall show and describe further, aspects of the present disclosure provide network anomaly monitoring services to cover the whole network infrastructure, as well as immediately diagnose and localize the physical link issue/failure, with the minimum cost (which is in terms of the number of sensing fiber routes/channels that need to be established). Our inventive techniques provide a unique encoding for each physical link, where each bit of the encoding corresponds to a sensing fiber route/channel.

When there occurs a single physical link failure, network carriers can examine the signal quality for all the sensing fiber routes/channels and derive an encoding that corresponds to a physical link, thus immediately localizing the failed physical link.

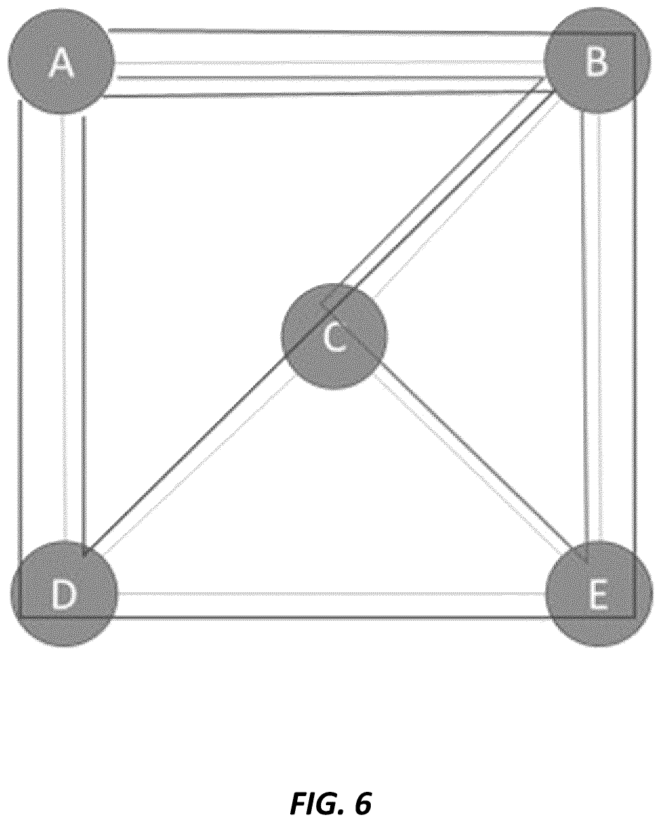

An illustrative example is shown in FIG. 6, which is a schematic block diagram showing an illustrative optical network for anomaly detection according to aspects of the present disclosure.

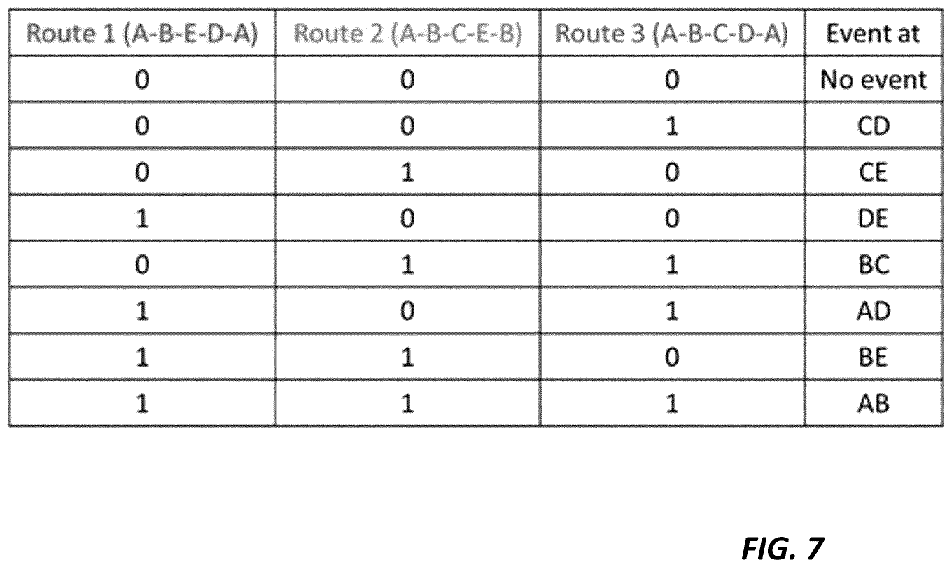

As illustratively shown in that figure and detailed in FIG. 7, which shows a set of data for network link encodings for failure detection of the illustrative optical network of FIG. 6, according to aspects of the present disclosure. As may be observed, the network infrastructure consists of 5 physical nodes and 7 physical links. Three DFOS sensing fiber routes/channels are established to provide the sensing service that covers the whole network infrastructure. Each physical link is encoded with a unique binary code (e.g., link BC corresponds to the encoding of 011). Here, each bit in the encoding corresponds to the signal quality of a DFOS sensing fiber route/channel, where 0 represents good signal quality and 1 represents bad signal quality. For example, if the network operator examines all the three DFOS sensing fiber routes/channels, and finds out that Route 1 (A-B-E-D-A) has good signal, while Route 2 (A-B-C-E-B) and Route 3 (A-B-C-D-A) have abnormal signal (such as a large SoP variation), then a signal quality code is constructed. This code can be used to immediately localize that the failure is at link BC, which is the overlapping link by Route 2 (A-B-C-E-B) and Route 3 (A-B-C-D-A). The proposed invention can produce the minimum number of DFOS sensing fiber routes/channels that achieve unique encodings for each physical link in the network infrastructure.

As we shall show and describe systems and methods according to aspects of the present disclosure efficiently diagnose and localize the physical link failure in an optical network. Furthermore systems, and methods according to aspects of the present disclosure provide the optimal (i.e. minimum) sensing fiber routes/channels allocation to cover the network infrastructure while immediate failure detection and localization is guaranteed. Finally, systems and methods according to aspects of the present disclosure generate unique encoding for each physical link that enables immediate failure detection and localization.

### Route Selection Procedure for Anomaly Detection and Localization

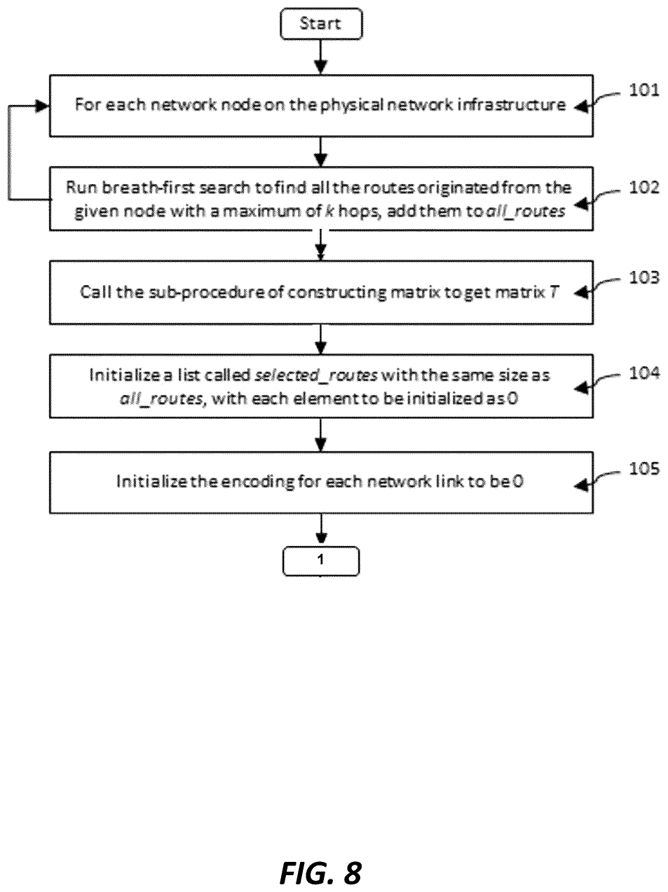

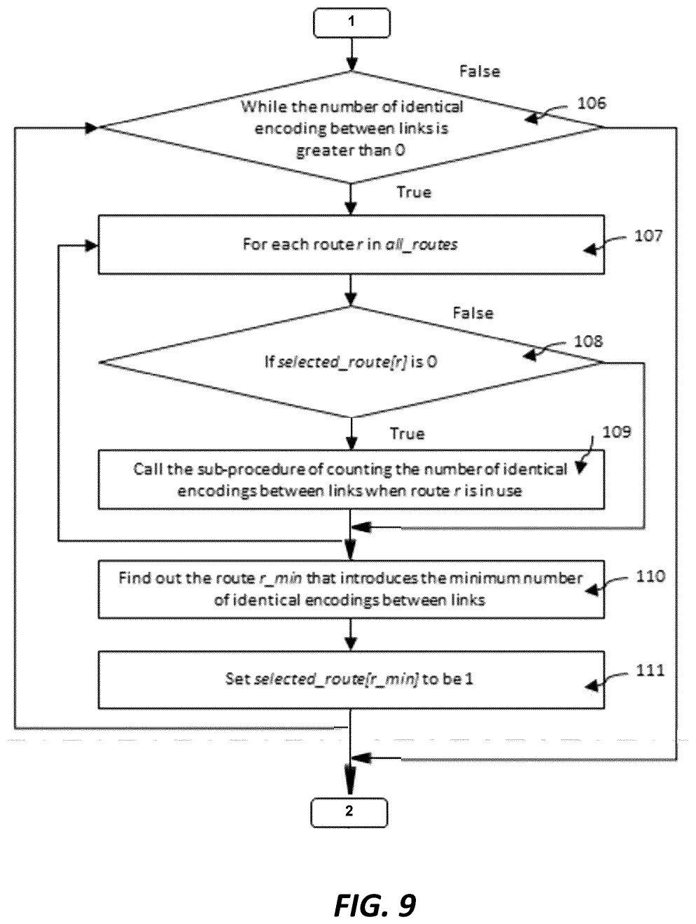

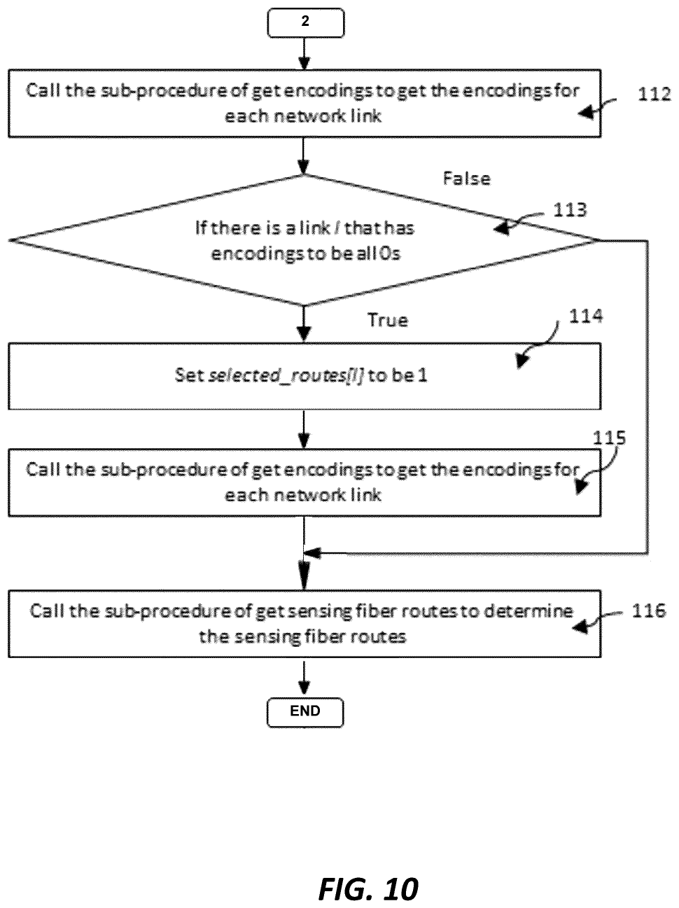

FIG. 8, FIG. 9, and FIG. 10 are flow diagrams that collectively show a main, computer-implemented procedure for network anomaly detection and localization according to aspects of the present disclosure. With simultaneous reference to these figures and as will become apparent upon examination to these and the remaining figures, our inventive localization procedure according to aspects of the present disclosure may be viewed as a main procedure and four sub-procedures. The main procedure involves 16 steps, which will be described as follows.

Step 101: This step is the starting point of a FOR loop. It is used for obtaining all the routes on the given physical network infrastructure. More specifically, this step will process each network node on the physical network infrastructure.

Step 102: This step will run the classic breath-first search algorithm to find all the routes originating from the given network node. Here, the routes will include all the routes from the given node with a communication hop at a maximum of k hops. The information of the routes will be stored in a list called all_routes.

Step 103: This step will call the sub-procedure to construct a matrix T, which consists of only 0s and Is. Matrix T has M rows and N columns, where M is the number of physical network links on the network infrastructure and N is the number of all the routes found in the previous two steps. Here, T[i][j] is 1 (where i∈[0, M], j∈[0, N]) means that link i is traversed by route j; 0 if link i is not traversed by route j.

Step 104: This step will initialize a list called selected_routes, which has the same size as all_routes. All the elements in selected_routes will be initialized as 0. In the future steps, when an element in selected_routes becomes 1, e.g., selected_routes[j] becomes 1, it represents that route j in all_routes, e.g., all_routes[j], is selected to be deployed for DFOS failure detection and localization.

Step 105: This step initializes the encoding for each network link to be 0.

Step 106: This step is the entering point of a while loop. It will check if there are identical encoding between different network links. More specifically, it will call the sub-procedure of counting the number of identical encodings between links. If the number of identical encodings is greater than 0, then it will enter the loop and repeat steps 107 through 111; otherwise, it will exit the while loop and go to step 112. This while loop makes sure that each network link has a unique encoding. Hence, if there is a single link failure, it can be detected immediately.

Step 107: This is the entering point of a FOR loop that is within the while loop in step 106. It will process each route r in all_routes.

Step 108: This step checks whether or not the given route r has been selected for deploying failure detection and localization. If the route has not been selected, e.g., selected_routes[r] is 0, then it becomes a candidate to be checked next in step 109; otherwise, the procedure goes back to step 107 to process the next route in all_routes.

Step 109: This step calls the sub-procedure of counting the number of identical encodings between links when route r is selected for deploying network anomaly detection and localization.

Step 110: This step finds out the route r_min that will introduces the minimum number of identical encodings between links in the current round of iteration of the while loop between step 106 and step 111.

Step 111: This step sets selected_routes [r_min] to be 1, representing that route r_min is selected for deploying DFOS failure detection and localization. The while loop between step 106 and step 111 is a greedy heuristic that keeps searching for the route that will introduce the minimum number of identical encodings between links, until all the links have different identical encodings. This heuristic makes sure that (1) each network link has a unique encoding and (2) the number of routes in use is minimized.

Step 112: This step calls the sub-procedure of get encodings to obtain the encoding for each network link.

Step 113: This step checks if there exists a network link that has encoding which consists of only 0s. If encoding bits are all 0s, even if it is a unique code, we cannot detect the failure using this code as all 0s means that all the sensing fiber routes function well with good quality. So, if this occurs, we will run step 114 and step 115 as follows to handle it; otherwise, it will proceed to step 116.

Step 114: This step will involve an additional route to be selected for deploying network anomaly detection and localization. More specifically, the route that consists of only one hop, i.e., link l, will be selected to deploy a sensing fiber route/channel for the failure detection and localization, so the procedure sets selected_routes[l] to be 1.

Step 115: This step will call the sub-procedure of get encodings to obtain the encoding for each network link again, which is purposed for updating the encodings after the update of selecting an additional route in step 114.

Step 116: This step will call the sub-procedure of getting all the sensing fiber routes to deploy the sensing fiber routes/channels for network anomaly detection and localization.

### The Matrix Construction Sub-Procedure

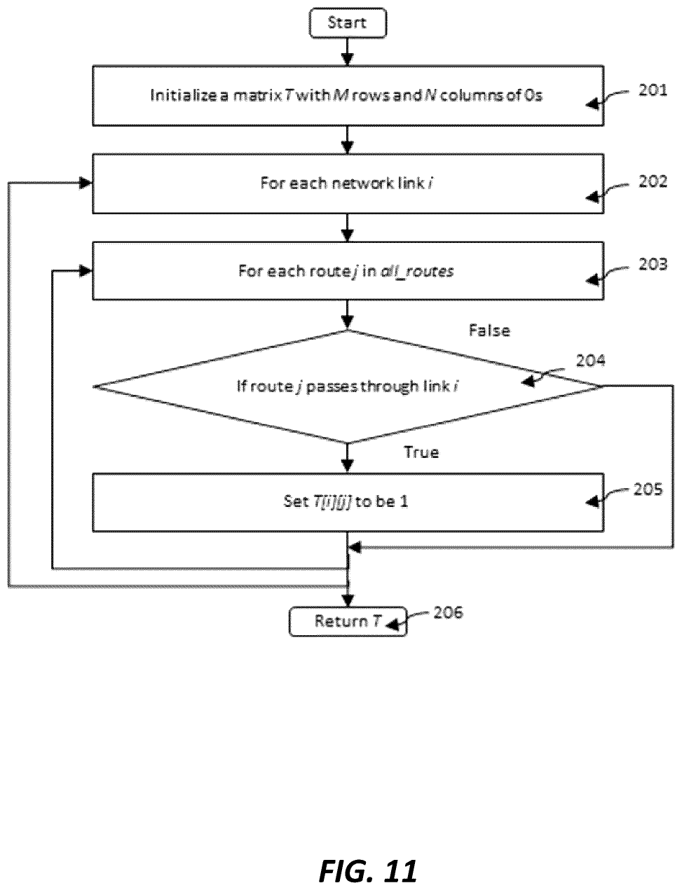

The matrix construction sub-procedure is called at step 103 in the network anomaly detection and localization main procedure. The flowchart of the matrix construction sub-procedure is shown in FIG. 11, which is a flow diagram that shows a computer-implemented sub-procedure for matrix construction for network anomaly detection and localization according to aspects of the present disclosure.

We will discuss the detailed steps for this sub-procedure as follows.

Step 201: This step initializes a matrix T, with M rows and N columns. Here, M is the number of network links in the network infrastructure and N is the number of all the routes found using the breath-first search with a maximum of K hops. Initially, all the elements in matrix T are set to be 0s.

Step 202: This step is an entering point of an outer FOR loop. It will check each network link i in the network infrastructure.

Step 203: This step is an entering point of an inner FOR loop. It will check each route j in all_routes.

Step 204: This step is the key step to determine the value of each item in matrix T. It will check if route j passes through network link i. If True, it will proceed to step 205; otherwise, it will go back to step 203 to check the next available route in all_routes.

Step 205: This step will set T[i][j] to be 1, which means that route j passes through network link i.

Step 206: Finally, after matrix T is constructed, it will be returned to the main procedure for further utilization.

### The Sub-Procedure for Counting Identical Encodings Between Links

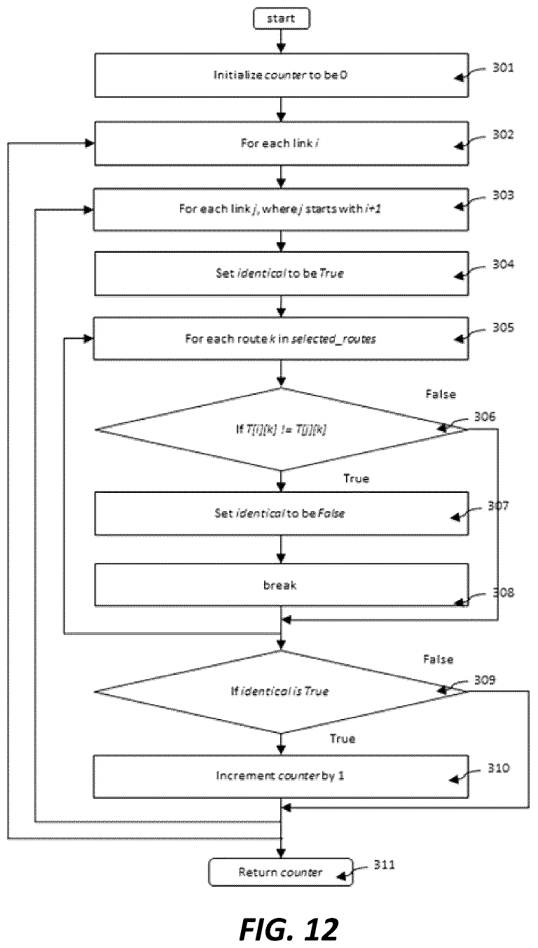

The sub-procedure for counting identical encodings is called in both step 106 and step 109 in the main proposed network anomaly detection and localization procedure. The flowchart of this sub-procedure is shown in FIG. 12, which is a flow diagram that shows a computer-implemented sub-procedure for counting the number of identical encodings between links for network anomaly detection and localization according to aspects of the present disclosure.

Step 301: This step initialize the counter of the identical encodings to be 0.

Step 302: This step is the entering point of an outer FOR loop. It will check each network link i.

Step 303: This step is the entering point of an inner FOR loop. It will check each network link j, where j starts with i+1. This will make sure that the proposed procedure is checking the encodings between two different network links.

Step 304: This step will create a new Boolean variable called identical, and set it to be True as initial value.

Step 305: This step is the entering point of an even inner FOR loop. It will check each selected route k in selected_routes. The loop will repeat steps 306 through 308 to check if the two given network links i and j have identical encodings.

Step 306: This step compares the encoding bit k between network link i and j. If it is different, then it will proceed to step 307; otherwise, it will go back to check the next selected route or bit k in step 305.

Step 307: This step sets identical to be False, representing that the two network links i and j have different encodings.

Step 308: This step breaks from the inner FOR loop in step 305, when the two network links i and j have different encodings.

Step 309: This step checks if the value of identical is True or False. If it is True, then it will proceed to step 310; otherwise, it will go back to step 303 to check the next network link j.

Step 310: This step will increment the counter for identical encodings by 1.

Step 311: Finally, after all the network link i finish comparison with a different network link j, via the double FOR loop in step 302 and 303, this step will return the counter back to the main proposed procedure.

### The Sub-Procedure of Generating Encodings

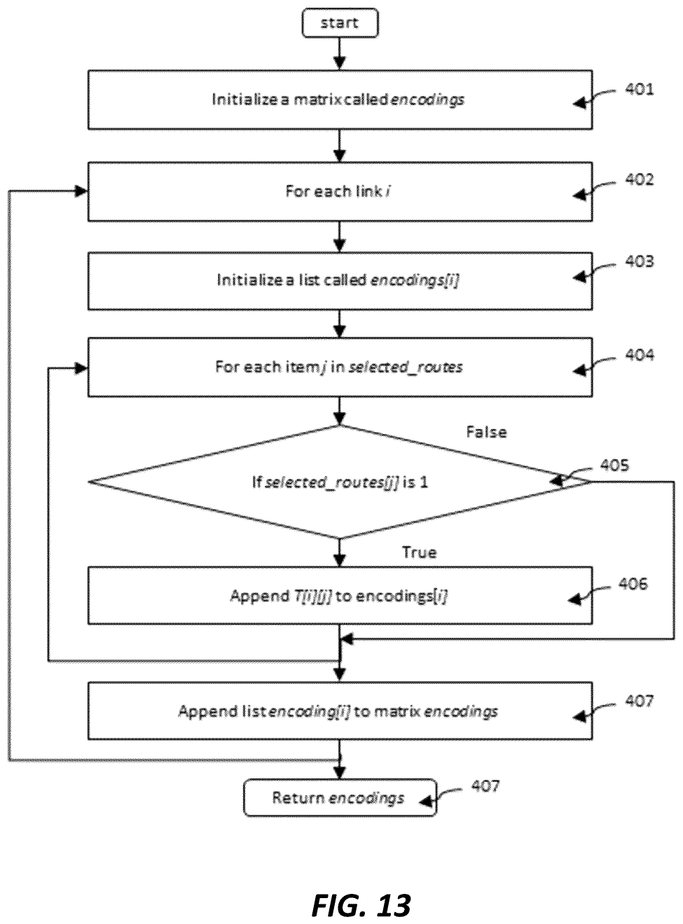

The sub-procedure of generating encoding is called in step 112 and step 115 in the main procedure of network anomaly detection and localization. The flowchart of this sub-procedure is shown in FIG. 13, which is a flow diagram that shows a computer-implemented sub-procedure for generating encodings for each link for network anomaly detection and localization according to aspects of the present disclosure. We will discuss the detailed steps as follows.

Step 401: This step will initialize a matrix called encodings, which is initially an empty list. It will grow to a matrix with M rows eventually, where M is the number of network links in the network infrastructure.

Step 402: This is the entering point of a FOR loop. It will check each network link i.

Step 403: This step initializes a list called encodings[i], which is an empty list initially. For each network link i, an encoding list or vector is created.

Step 404: This step is the entering point of an inner FOR loop. It will check each selected routes j in the list of selected_routes.

Step 405: This step checks if selected_routes[j] is 1 or not. If selected_routes[j] is 1, it means this route j is selected to be used for deploying DFOS sensing fiber routes/channels for DFOS failure detection and localization, then the next step will proceed to step 406; otherwise, it will go back to the FOR loop in step 404.

Step 406: This step will append T[i][j] to the list of encodings[i]. It means that if route j is selected for deploying sensing fiber routes/channels, the information that whether route j passes through link i will be added to the encoding of link i, which is encodings[i].

Step 407: This step adds the encoding of link i to the encoding matrix namely encodings. After the inner loop between step 402 and step 406 completes, the encodings for link i is complete. It can be added to the encoding matrix encodings.

Step 408: This step returns the matrix encodings to the main proposed procedure.

### The Sub-Procedure of Assigning Sensing Fiber Routes/Channels

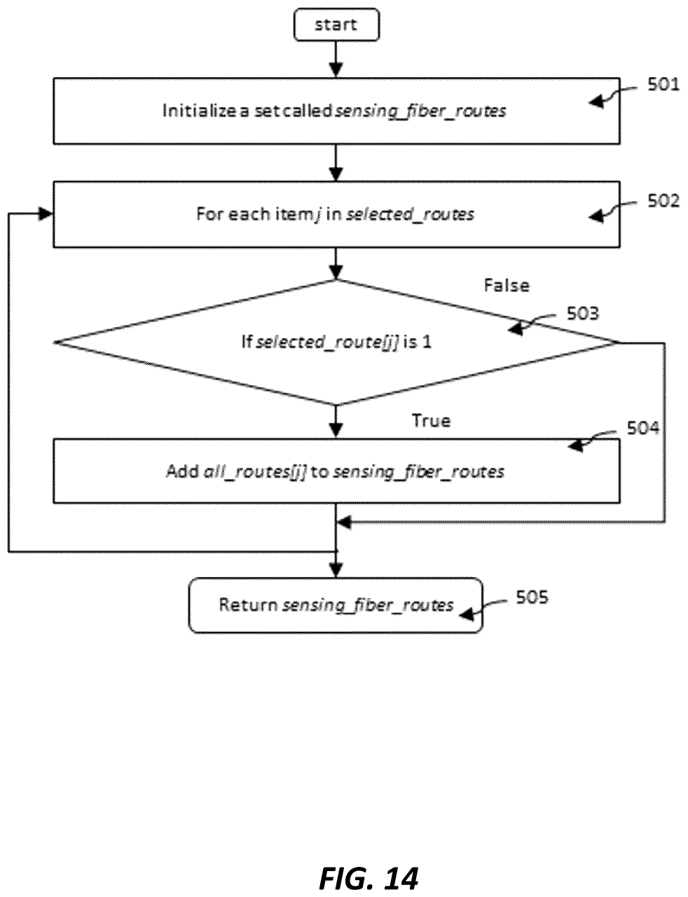

The sub-procedure of assigning sensing fiber routes/channels is called in the main proposed procedure in step 116. The flowchart of this sub-procedure is shown in FIG. 14, which is a flow diagram that shows a computer-implemented sub-procedure for sensing fiber routes/channels for network anomaly detection and localization according to aspects of the present disclosure. We now discuss the detailed steps in the following parts.

Step 501: This step initializes a set called sensing_fiber_routes, which is empty at the beginning.

Step 502: This step is the entering point of a FOR loop. It checks each selected route j in selected_routes.

Step 503: This step checks the value of selected_routes[j]. If the value is 1, it means that route j is selected for deploying sensing fiber routes, then it will proceed to step 504; otherwise, it represents that route j is not used, then the procedure goes back to step 502 to check the next value in selected_routes.

Step 504: This step will add the detailed routing information (e.g., the routing path that originates from the source network node, traverses through multiple intermediate nodes and finally arrives at the destination network node) to the set of sensing_fiber_routes.

Step 505: This step will return the set sensing_fiber_routes to the main proposed procedure.

### Experimental—Network Anomaly Detection and Localization Based on Forward Transmission Sensing

As we have noted, our inventive network anomaly detection scheme is based on forward transmission sensing and network-wide global planning of the sensing routes. First, multiple sensing routes are selected to cover the entire network and each link in the network is guaranteed to contain a different combination of sensing routes. These routes are then monitored concurrently and analyzed centrally. When an anomaly event occurs at a specific link, the receivers in the corresponding routes will detect the optical characteristic change. Since the sensing route combination is unique for each link, the global analysis of the optical characteristic change will indicate the exact link that causes the event.

Returning our attention once again to FIG. 1, there is shown an example mesh network with 5 nodes and 7 links. Three sensing routes are set up as shown in FIG. 1 and FIG. 2. With this arrangement, each link has a unique combination of sensing routes. Three of the links (CD, CE, and DE) are traversed by three unique routes. Three other links (AD, BC, and BE) are traversed by two unique sets of routes, and the last link (AB) has all three routes overlapped. When an event occurs on a specific link, the receiver at the corresponding routes will report abnormal optical characteristics, as indicated by 1's in FIG. 2, otherwise it is shown as 0. For N routes, an N-digit binary code will thus be formed. The route selection ensures that each link has a unique code, which can easily localize the link if an event occurs. For example, if an anomaly occurs at link BC, the code 011 will be obtained since Route 2 and Route 3 will report the abnormal optical characteristics and Route 1 will not. From this “011” code, the anomaly event at link BC can be instantly identified.

### Sensing Route Optimization Algorithm and Analysis

To apply this detection scheme, it is desirable to keep the number of sensing routes to a minimum while still covering the entire network with per-link identification capability. For a network with N links, the trivial upper bound is N routes, but this is not efficient. The theoretical lower bound is [log ₂ (N+1)], since it needs to differentiate among N links and the “no event” case. Here, we do not consider the case of simultaneous multiple events, since it is rare that anomaly occurs on more than one link at the same instant of time. As long as there is a brief time gap between two events, they can be identified and localized one at a time. The example illustrated in FIG. 1 shows the theoretical lower bound case of 3 routes when N is 7. However, this theoretical lower bound is seldom achievable since it only works on specific network configurations. Here, we develop a novel heuristic algorithm to find the optimal route selection for any network configurations or topologies.

Our inventive heuristic algorithm aims at assigning the minimum number of sensing routes such that (1) each link is sensed or covered at least by one sensing route and (2) each link is associated with a unique binary code that is not all 0s (which indicates no anomaly event). Here, the code between different links is required to be non-identical, so that the anomaly event can be localized immediately. The proposed heuristic algorithm is a greedy algorithm that includes four steps.

Firstly, it applies breadth-first search to obtain all the routes that originate from each node with a maximum of k hops.

Secondly, a matrix T with links as rows (N rows) and all the routes as columns (M columns) can be constructed, as shown in FIG. 2. Here, T[i][j] is 1 if route j passes through link i; 0 otherwise.

Thirdly, the algorithm examines each route and selects the one that introduces the minimum number of identical codes between links for deploying a new sensing route. This step repeats until there is no identical code between different links.

Finally, after the above iteration is complete, if one of the links has a code consisting of all 0s, a new sensing route (only one hop) will be deployed to just cover this particular link. This is because, even if all 0s is a unique code, it represents there is no abnormal optical characteristic change found at any route, which cannot be used for identifying anomaly event at any link.

We also developed an integer linear programming (ILP) model to obtain the optimal solution. We assume that M routes are found using the breadth-first search. A variable δₖ, k∈M is defined to be 1 if route k is selected for deploying sensing route; 0 otherwise. The objective is to minimize the number of sensing routes, which is defined as:

$$min = 1 \sum {M}_{k} {δ}_{k}$$

$$s . t . \sum {M}_{k = 1 \vert {T}_{i , k}} \cdot {δ}_{k} - {T}_{j , k} \cdot {δ}_{k} \vert \geq 1 ∀ i {∈}_{N , j} ∈ [ i + 1 , N ] \qquad ( 1 )$$

$$\sum {M}_{k = 1} {T}_{i , k} \cdot {δ}_{k} \geq 1 ∀ i {∈}_{N} \qquad ( 2 )$$

Here, Eq. (1) ensures that the code for each link is unique, so that any anomaly can be localized immediately. Eq. (2) guarantees that each link's code contains at least one 1, which means that a link is at least sensed by =1 one sensing route. Here, Eq. (1) is non-linear, which is not directly solvable. We define an auxiliary matrix A that has three dimensions, where A[i][j][k] is 1 if T[i][k] is equivalent to T[j][k] (meaning that links i and j have identical code at bit k when route k is selected); 0 otherwise. Then, the first constraint can be transformed to Eq. (3), which becomes linear and is solvable.

$$\sum {M}_{k = 1} {A}_{i , j , k} \cdot {δ}_{k} \geq 1 ∀ i ∈ N , j ∈ [ i + 1 , N ] \qquad ( 3 )$$

Compared to the heuristic algorithm, the ILP solution sets up the practical lower-bound benchmark. However, it may not be tractable when the network size is large.

We conducted a set of comprehensive simulations to evaluate the performance of the proposed greedy algorithm and the ILP solution. The upper bound N is also listed for comparison. Firstly, we evaluate the number of sensing routes used across different real-world optical networks, using breadth-first search for routes with a maximum of 4 hops. From our results we learned that the greedy algorithm achieves a performance that is close to the optimal solution obtained by the ILP model. As the network size increases, the proposed greedy algorithm continues to achieve an efficient performance, while ILP cannot yield to a solution. Furthermore, the idea that more available routes may give us a better pool of sensing routes motivates us to evaluate how the maximum number of hops k may affect the performance of the greedy algorithm. What we determined—as the maximum hops k increases (which introduces more available routes to the pool)—the number of sensing routes used by the greedy algorithm decreases.

As we learned, the feasibility of our network monitoring and anomaly detection scheme is verified experimentally. We set up a 5 node network with the same topology as the example in FIG. 1. The optical channels are commercial 400 Gb/s CFP2DCO pluggable modules managed by open transponders. Six DCO modules were used in this experiment to set up communication on three routes, with three used as transmitter and three as receiver. The maximum SoP rotation speed was reported by each receiver transponder every second, which is used as the monitoring parameter. The transmission quality of each route is monitored by the built-in pre-FEC BER readouts from the DCOs, which were also updated every second. Broadband optical signals are added through a wavelength-selective switch to emulate other WDM channels. The links contain multiple fiber spools with standard single mode fibers (SSMF) between 20 km and 80 km, and short sections of multi-strand optical cable when multiple routes converge. The nodes consist of wavelength-selective switches and optical amplifiers.

During our experiment, shaking, twisting, or bending actions were applied to each link to emulate anomaly events. Each action lasted 2 to 4 seconds. The SoP speed on all three routes were read concurrently.

A threshold of 500 rad/sec was set to determine whether an anomaly occurs. The combed analysis results from three channels forms the binary code that instantly indicates the link where the anomaly occurs. The experiment results match well. For example, when a section of link AD is shaken, both Routes 1 and 3 experience large SoP change, while the SoP at Route 2 remain normal (well below the threshold). During the operation, all transponders continued to transmit data error-free.

### CONCLUSIONS

We introduced and experimentally demonstrated a forward transmission sensing-based scheme for network monitoring and anomaly detection. A close-to-optimum heuristic algorithm was developed for sensing route selection. This solution efficiently detects and localizes otherwise invisible physical anomalies in large-scale optical networks and provide advance warning before any anomaly causes transmission quality deterioration or fiber cut.

### Potential for Network Application.

We have demonstrated the effectiveness of the acoustic data transmission using an OFDM signal to address the problems associated with data transmission using a DAS, such as multipath fading impacting the BER and limitations in the acoustic transmission bandwidth. This study offers a foundation for further exploration of optical fiber sensing technology in the context of large-scale communications, potentially leading to enhanced data transmission efficiency and quality.

At this point, while we have presented this disclosure using some specific examples, those skilled in the art will recognize that our teachings are not so limited. Accordingly, this disclosure should be only limited by the scope of the claims attached hereto.

1. A computer implemented method for optical network anomaly detection and localization using forward transmission sensing, the method comprising:
by the computer:
determine multiple sensing routes through the optical network that the entire optical network is covered, wherein each link in the optical network has a different combination of sensing routes;
concurrently monitoring and centrally analyzing the multiple sensing routes for anomalous events;
detecting an anomalous event at a specific link in the optical network; and
determining a unique sensing route combination for the specific link in the optical network having the detected anomalous event; and
determining the specific link in the optical network having the detected anomalous event from the determined, unique sensing route combination.

2. The method of claim 1 wherein a minimal number of multiple sensing routes is determined wherein the minimal number of multiple sensing routes so determined covers the entire optical network with per-link identification ability.

3. The method of claim 2 wherein the minimal number of multiple sensing routes so determined is represented by log 2 (N+1), where N is the number of links in the optical network.

4. The method of claim 3 wherein the multiple sensing routes are determined by a greedy algorithm.

5. The method of claim 4 wherein the greedy algorithm applies a breadth-first-search to obtain all routes that originate from each node with a maximum of k hops.

6. The method of claim 5 wherein the greedy algorithm defines a matrix T, with links as rows (N rows) and all the routes as columns (M columns) in the matrix T.

7. The method of claim 6 wherein the greedy algorithm examines each route and selects one that introduces a minimum number of identical codes between links for deploying a new sensing route and repeats this examination, selection, introduction process until there is no identical code between different links.

8. The method of claim 7 wherein if a link exhibits a code of all 0s, a new sensing route of only one hop is deployed to cover this particular link with all 0s.
